(19) United States
(12) Patent Application Publication
(10) Pub. No.: US 2023/0001968 A1
(43) Pub. Date: Jan. 5, 2023

(54) Remote Wear Monitoring of Components in a Railway Rail Fastening System

(71) Applicant: Pandrol Limited, Addlestone Surrey (GB)

(72) Inventors: Stephen John Cox, Richmond Surrey (GB); John David Spencer, Effingham Surrey (GB); John Phillip Porrill, Godalming Surrey (GB)

(21) Appl. No.: 17/366,434

(22) Filed: Jul. 2, 2021

(51) Int. Cl. B61L 25/06; G01N 21/88; G06T 7/00; G06K 9/62; G06K 9/00; G06N 3/08

(52) U.S. Cl. CPC B61L 25/06; G01N 21/8851; G06T 7/0002; G06K 9/627; G06K 9/6201; G06K 9/00214; G06N 3/08; G06T 2207/10028

(57) ABSTRACT

Methods of assessing wear of an electrical insulator and rail pad of an assembled rail fastening system utilize data from a 3D scan of the system to derive measurements of the system from which wear of the side post of the electrical insulator, or wear of the rail pad beneath the rail, may be assessed.

### FIELD OF THE INVENTION

The present invention relates to remote wear monitoring of components in a railway rail fastening system.

### BACKGROUND OF THE INVENTION

A railway rail fastening system for fastening a railway rail to an underlying track foundation, such as a wooden or concrete sleeper (tie) or slab track, typically comprises two fasteners in the form of rail clips for location one on either side of a rail, and respective rail clip anchoring devices (which may be integrally formed with a baseplate secured to the foundation or cast in) for retaining the rail clips when the rail clips bear on the foot of the rail. When the foundation is a concrete sleeper or slab, the system typically further comprises an elastic rail pad, for location between the rail foot and the underlying foundation, and electrical insulators (which may be in one or two parts), each comprising a side post, for insulating the rail clip anchoring device from the rail which is to be located between the edge of the rail foot and a front face of the rail clip anchoring device, and a blade or toe portion, for insulating the rail clip from the rail. There are many different types of railway rail fastening system, which differ from one another in various ways, for example in the kind of rail clip they use, and/or the kind of anchoring device they have, and/or the kind of rail pad and/or electrical insulators they employ.

During use in track, all components of a fastening system will undergo wear to some extent, but those which wear most quickly are the rail pad and the side posts of electrical insulators on the field side of the rail (i.e. the outer side of the rail in track); side post wear is one of the major failure mechanisms of fastening systems. Consequently, the wear condition of the rail pad and electrical insulators must be checked regularly. Conventionally, in order to check the condition of an electrical insulator in situ accurately, it is necessary to dismantle the assembled rail fastening system, as the side post is hidden below the blade of the insulator. A similar issue arises with checking wear of the pad, where in addition the rail must be lifted. Such checks are time-consuming and labour-intensive processes which require lengthy closure of the track to rail traffic, before it is even known whether replacement of any components is required.

It is therefore desirable to provide a faster and less intrusive way to assess the wear of electrical insulators and/or rail pads in track.

The type of fastening system (and/or the rail section) may vary along the length of a track, but records of exactly which type of fastening system and/or which rail section are in use at every location along a track are not always available, or easily interpreted. As one of the first jobs in assessing condition is to know what type of system and rail section is being inspected, inspection must be carried out by an experienced track engineer familiar with many different fastening systems and rail sections.

Accordingly, it is also desirable to facilitate identification of rail fastening systems and/or rail sections for use in assessing condition of component wear.

### SUMMARY OF THE INVENTION

According to an embodiment of a first aspect there is provided a computer-implemented method of assessing wear of a side post of an electrical insulator, wherein the electrical insulator is part of an assembled railway rail fastening system securing a rail foot of a railway rail, the method comprising: obtaining data derived from a three-dimensional, 3D, scan of a region comprising at least part of the rail and at least a reference portion of the assembled railway rail fastening system; deriving from the data at least one measurement indicating a distance between a point on the rail and the reference portion of the assembled railway rail fastening system; and assessing wear of the side post of the electrical insulator based on the at least one measurement.

The reference portion may be a portion of a rail clip anchoring device of the assembled railway rail fastening system. The portion of the rail clip anchoring device may be a front edge of the rail clip anchoring device adjacent to the edge of the rail foot, or a rear edge of the rail clip anchoring device opposite to the front edge.

If the rail is supported by a railway baseplate providing or connected to a rail clip anchoring device of the assembled railway fastening system, the reference portion may be a portion of the railway baseplate.

The point on the rail may be on one of the edges of the rail foot.

Assessing wear of the side post of the electrical insulator may comprise: comparing the derived value of the measurement with a stored value for the measurement; and outputting the result of the comparison. The stored value may be obtained from data derived from an earlier 3D scan of the region. The stored value may be one of: a value of the measurement for the electrical insulator obtained before the railway rail fastening system was assembled; a typical value of the measurement for an unused electrical insulator of the same type as the electrical insulator in the assembled railway rail fastening system.

According to an embodiment of a second aspect there is provided a computer-implemented method of assessing wear of a rail pad, wherein the rail pad is part of an assembled railway rail fastening system securing a rail foot of a railway rail to a rail support and is located at least partly between a bottom surface of the rail foot and the rail support, the method comprising: obtaining data derived from a three-dimensional, 3D, scan of a region comprising at least part of a top surface of the rail foot and at least one fixed point spaced from the rail; deriving from the data at least one measurement indicating a vertical distance between the top surface of the rail foot and the at least one fixed point; and assessing wear of the rail pad based on the at least one measurement.

The rail support may be a track foundation, and the fixed point may be located on a top surface of the track foundation, or the rail support may be a baseplate secured to a track foundation, and the fixed point may be located on a top surface of the baseplate or the track foundation.

The at least one measurement may indicate the thickness of the rail pad beneath the rail foot on one side of the rail.

The region in the 3D scan may comprise at least a part of the top surface of the rail foot on each side of the rail. At least two measurements may be derived from the data. One of the measurements may indicate a vertical distance between the top surface of the rail foot on one side of the rail and the at least one fixed point. Another of the measurements may indicate a vertical distance between the top surface of the rail foot on the other side of the rail and either the at least one fixed point or another fixed point visible in the 3D scan. The at least two measurements may indicate the respective thicknesses of the rail pad beneath the rail foot on each side of the rail. The at least two measurements may be averaged to obtain an assessment of the overall wear of the rail pad beneath the rail foot, or used to determine an angle of cant of the rail from which an assessment of wear of the rail pad on each side of the rail may be obtained.

Assessing wear of the rail pad may comprise: comparing the derived value of the measurement with a stored value for the measurement; and outputting the result of the comparison. The stored value may be obtained from data derived from an earlier 3D scan of the region. The stored value may be one of: a value of the measurement for the rail pad obtained before the railway rail fastening system was assembled; a typical value of the measurement for an unused rail pad of the same type as the rail pad in the assembled railway rail fastening system.

In an embodiment according to the first or second aspect, obtaining the data may comprise: extracting measurement data from an image produced from a combination of an image of the region obtained from the 3D scan with one of (i) an image of a 3D model of the assembled railway rail fastening system and (ii) an image of the assembled railway rail fastening system created before the 3D scan.

A method embodying the first or second aspect may further comprise, before assessing wear, using the 3D scan to determine at least one of: an identity of the assembled railway rail fastening system; a type of the assembled railway rail fastening system; a type of the electrical insulator; a type of a component of the assembled railway rail fastening system other than the electrical insulator.

Determining the identity or type may be carried out by: matching the 3D scan with at least part of (i) an assembled railway rail fastening system from a database of assembled railway rail fastening systems or (ii) a 3D model of an assembled railway rail fastening system from a database of 3D models of assembled railway rail fastening systems; and determining that the assembled railway rail fastening system matched with the 3D scan is an assembled railway rail fastening system having the same identity, or is of the same type, as the assembled railway rail fastening system in the 3D scan. Assessing wear may comprise using a stored value for the measurement which is associated with the assembled railway rail fastening system with which the assembled railway rail system in the 3D scan has been matched.

Determining the identity or type may be carried out using a neural network trained as a classifier.

In embodiments according to the first or second aspect, one or each 3D scan may be obtained using one of: a LiDAR scanner; a structured light scanner; a stereo depth scanner.

### BRIEF DESCRIPTION OF THE DRAWINGS

FIG. 1A is a drawing of a section on the centreline of one type of assembled railway rail fastening system;

FIG. 1B is a view of a portion of the rail fastening system of FIG. 1A;

FIG. 2 is a flowchart of a method according to an embodiment of a first aspect;

FIG. 3A is a top view of an assembled rail fastening system, FIG. 3B is a top view of a portion of the rail fastening system of FIG. 3A, and FIG. 3C is a cross-sectional view of the rail fastening system of FIG. 3A, for use in explaining an embodiment of the first aspect;

FIG. 4 is an image of part of an assembled railway rail fastening system;

FIG. 5A and FIG. 5B are respective cross-sectional views of an assembled railway rail fastening system for use in explaining embodiments according to the second aspect;

FIG. 6A is a section of a type of railway rail, and FIG. 6B shows a detail of FIG. 6A;

FIG. 7 is a flowchart of a method according to an embodiment of a second aspect; and

FIG. 8 is a block diagram of a computing device suitable for carrying out a method according to an embodiment.

### DETAILED DESCRIPTION

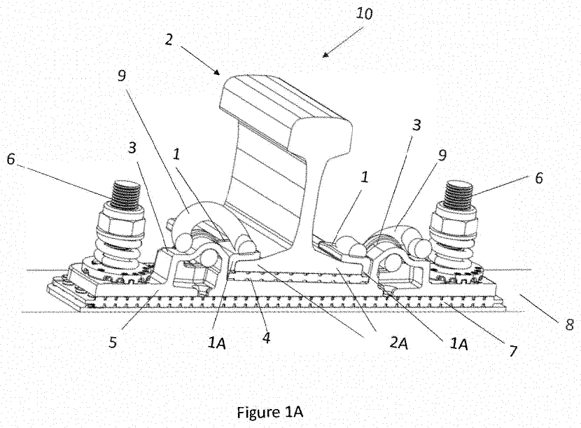

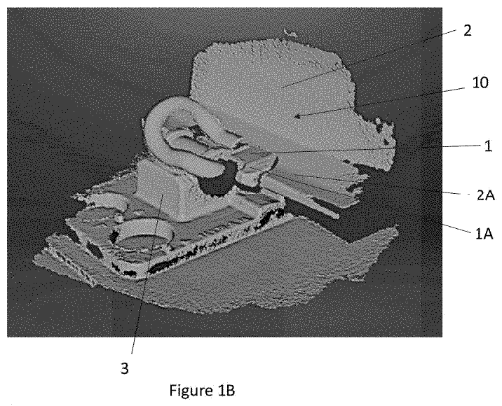

A drawing of a section on the centreline of one type of assembled railway rail fastening system 10 is shown in FIG. 1A. A 3D scan image of the field side of such a rail fastening system 10 is shown in FIG. 1B. As illustrated in FIG. 1B, as a side post 1A of an electrical insulator 1 located between a foot 2A on the field side of a rail 2 and a rail clip anchoring device 3 retaining a rail clip 9 in an assembled railway rail fastening system 10 wears owing to passage of trains over the track, the rail 2 will over time move towards the rail clip anchoring device 3, the position of which is fixed relative to the track foundation. In an embodiment of the invention, the lateral position of the rail 2 relative to the anchoring device 3 is measured at suitable time intervals whilst the railway rail fastening system 10 is still in an assembled state, and the change in this measurement over a period of monitoring is used to determine a value for the wear of the insulator side post 1A on the field side of the rail 2. For example, side post wear may be assessed by measuring the position of the rail (for example, a near or far edge of the rail foot 2A which is visible in the scan) relative to a fixed point on the anchoring device 3 (for example the front edge adjacent to rail foot 2A or the opposite, rear edge), or on a baseplate if a baseplate is present. The measured distance from the rail to the fixed point may be compared to a known reference distance, and from the difference between the measured and reference distances an indication of a degree of wear of the side post 1A may be determined.

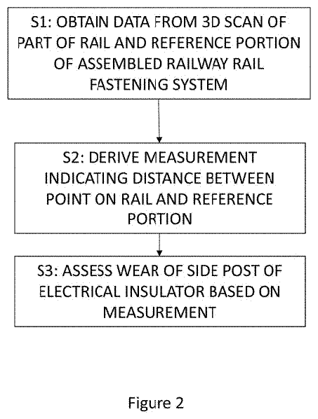

FIG. 2 is a flowchart of a computer-implemented method embodying the present invention which may be used to assess wear of a side post of an electrical insulator, where the electrical insulator is part of an assembled railway rail fastening system securing a rail foot of a railway rail. In step S1, data derived from a 3D scan of a region comprising at least part of the rail and at least a reference portion of the assembled railway rail fastening system is obtained. In step S2, at least one measurement indicating a distance between a point on the rail and the reference portion of the assembled railway rail fastening system is derived from the data. In Step S3, wear of the side post of the electrical insulator is assessed based on the at least one measurement

In contrast to the conventional method which requires the railway rail fastening system to be dismantled before the side post 1A of the insulator 1 is clearly visible, in an embodiment of the invention the measurement may be extracted from a 3D scan of the assembled railway rail fastening system 10, taken vertically above the system 10 or at an angle to the vertical, even if the side post 1A is obscured. The 3D scan may be obtained using one or more of a structured light scanner, a LiDAR scanner, a stereo depth scanner, or any other suitable technology. For example, in one embodiment, the scanner may be hand-held and operated by someone walking the track. In another embodiment the scanner may be secured to a track vehicle (such as a train or trolley) movable along the track and operated either manually or automatically. The scanner may comprise a single camera or multiple cameras. The scanner may be positioned vertically or at an angle above all or part of a rail fastening system in order to capture one or more images of all or part of the rail fastening system. The scanner may be operable to take scans of the rail fastening system on only one side (i.e. field side) of the rail, or simultaneously of the rail fastening system on both sides of the rail.

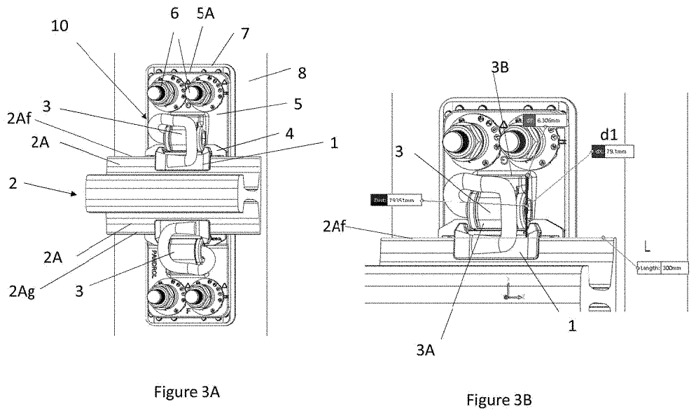

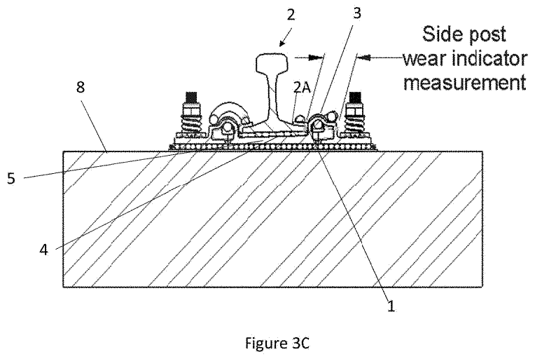

FIG. 3A is a drawing of an assembled railway rail fastening system 10, which is provided to illustrate an example of a measurement which may be extracted from a 3D scan in order to assess the thickness of the side post of insulator 1, and FIG. 3B is an enlarged portion of the field side of the system 10 shown in FIG. 3A. In this example, anchoring device 3 is integrally formed as part of a baseplate 5, which is in turn secured by bolts 6 to an underlying railway sleeper 8. A rail pad 4 is located between the rail foot 2 and the baseplate 5, and a baseplate pad 7 is located between the baseplate 5 and sleeper 8. FIG. 3B illustrates that a measurement may be extracted from a 3D scan of such an assembled railway rail fastening system 10, from which the thickness of the side post may be deduced, namely the distance dl between a line L denoting the edge 2Af of the rail foot 2A on the field side of the rail 2 and a rear edge 3B of the field-side anchoring device 3, both of which may be clearly visible in the scan. Alternatively, measurement may be made of the distance between line L and a front edge 3A (or another portion) of the field-side anchoring device 3, or between line L and another fixed point (for example an end 5A of the baseplate 5), or between a line (not shown) denoting the edge 2Ag of the rail foot 2A on the gauge side of the rail 2 (or another part of the rail 2) and any fixed point on the anchoring device 3 or baseplate 5. FIG. 3C, for example, shows a measurement of the distance between a line (not shown) denoting the edge of a rail foot on the gauge side of the rail and the rear face of the adjacent anchoring device.

A first method of using 3D scanning to assess wear is to make a series of scans at different points in time of the same part of a particular fastening system. By comparing one scan to another made earlier, it is possible to determine what has changed in the intervening period, and to correlate the differences with wear of those components of the system which are expected to wear. An advantage of this is that in principle it is not necessary to have identified the type of rail fastening system shown in the scans.

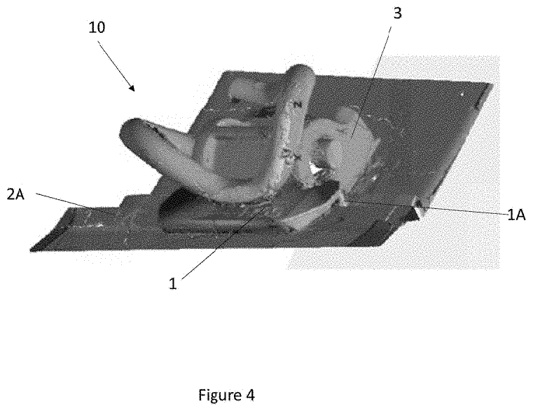

Thus, one way of obtaining a wear measurement is by extracting measurement data from an image produced from a combination of an image of the region obtained from the 3D scan with one of (i) an image of a 3D model of the assembled railway rail fastening system and (ii) an image of the assembled railway rail fastening system created before the 3D scan. For example, FIG. 4 shows a greyscale image of part of an assembled railway rail fastening system made by combining two 3D scans, the first performed at a reference time point and the second performed after elapse of a period of time during which forces have been applied to the assembled railway rail fastening system during use in track. The effect of the wear resulting from the applied forces on the fastening system is shown by different shades of grey (ideally a colour image would be used to illustrate the regions of wear more clearly using a colour scale, for example red showing areas of greatest wear, green showing areas with no wear). Differences in any of the X-Y-Z directions may be measured directly from the scan, and resolved to fractions of a millimetre.

In order to find out from a measurement of the lateral position of the rail 2 relative to the anchoring device 3 how much the side post 1A has worn, it is necessary to know what this measurement was initially when the system 10 was installed. The scan comparison process described above will give measurements of change, but it cannot provide information about the initial measurements (and therefore how much residual life there might be in the components) unless this information is supplied by other means. For example, without information on the rail fastening system shown in the scans, it may be difficult to distinguish between a brand new (unworn) 5 mm thick rail pad and a 10 mm thick rail pad that has worn down to 5 mm thickness.

To obtain the initial measurements, it is necessary to know which particular one of the systems 10 is shown in the 3D scan or, on the assumption that the initial relative position of components in an assembled system 10 of a particular type will always be the same (within an acceptable tolerance), what type of system it is. Of course, such information may be readily obtained if a database containing detailed data relating to the types and/or particular identities of systems installed along a track is available. However, as mentioned above, such detailed data is often absent or hard to interpret. If so, an alternative source of information is required.

In this case the required information may be obtained using a second method of assessing wear (which may be used alone or together with the first method) in which what rail fastening system (or component of a rail fastening system) is shown in a scan is identified by matching it with a stored model of a 3D fastening system from a database of different designs of rail fastening system (which might number in the hundreds). By doing so it may be possible to extract much more detail relating to the fastening system, including the exact positions of parts that are not visible, either by eye or in the scan, for example exactly where the hidden edge of the anchoring device 3 and the hidden surface of the sleeper rail seat under the rail 2 are located.

For example, one way of obtaining information on initial/unworn measurements is to determine the identity or type of the system by comparing a 3D scan of the system in track with 2D images or 3D scans of various different systems to find a matching system, and obtaining the information required from information stored in respect of the matching system. Another way of obtaining the necessary information is to determine the identity or type of the system by comparing a 3D scan of the system in track (desirably, for example, the same 3D scan from which measurements have been or are to be derived) to a stored 3D model of the system in its intended configuration, i.e. how it was at installation. That is, a database of 3D models of different types of system is provided against which the 3D scan is compared to find a matching 3D model. In each case, matching to determine the identity or type of a system may be carried out automatically, for example using a neural network trained as an image classifier.

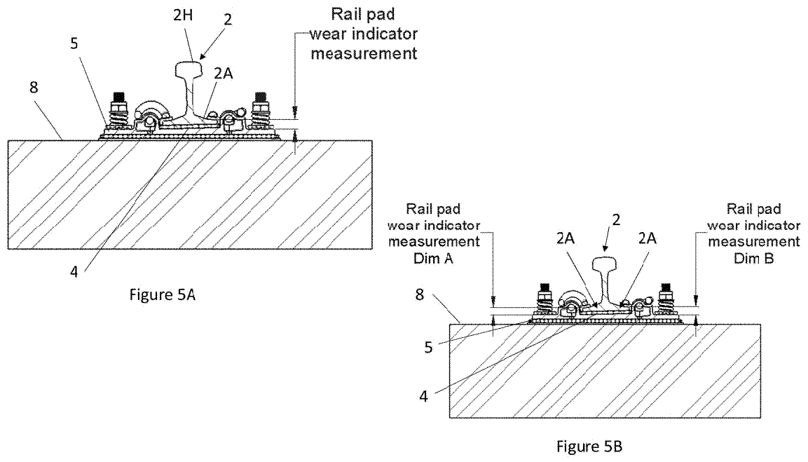

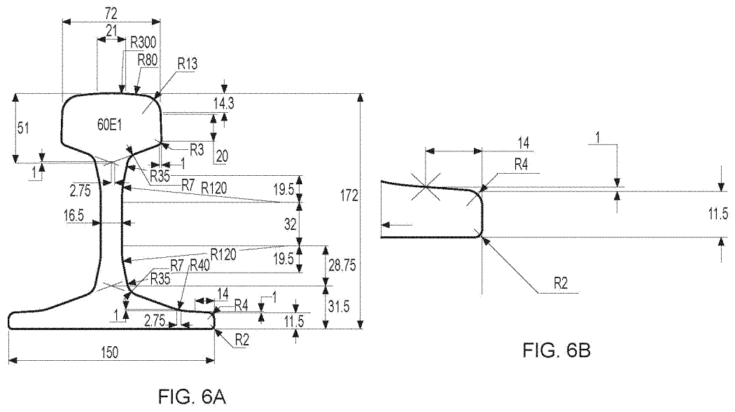

As mentioned above, it is also desirable to be able to obtain measurements of rail pad thickness in order to assess rail pad wear. A worn rail pad 4 fills the gap between two (likely non-parallel) planes, that is the bottom surface of the rail foot 2A and the top surface of the underlying rail support, e.g. baseplate 5, neither of which can be seen in a scan of the system in track. However, rail pad wear may be assessed from a measurement of the height of the rail head 2H to the top of the baseplate 5 (or another fixed point visible in the scan), or more preferably from a measurement of the height of the rail foot 2A on one or both sides of the rail 2 to a visible fixed point (or points) on the top of the baseplate 5 (or another known fixed point), as shown in FIGS. 5A (one side) and 5B (both sides). In one embodiment, the height of the rail foot (or each rail foot) is measured from a fixed point on the rail foot where there is a change in section, this point being particular to each type of rail. FIG. 6A shows a rail section of a 60E1 section rail and FIG. 6B shows a detail of the rail foot of FIG. 6A with example measurement points.

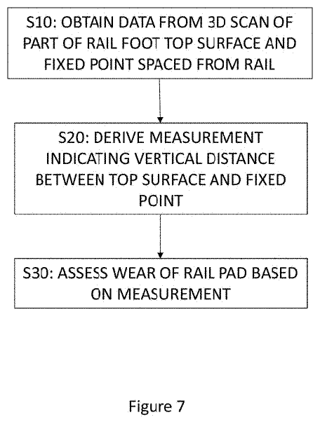

FIG. 7 is a flowchart of a computer-implemented method embodying the present invention which may be used to assess wear of a rail pad, wherein the rail pad is part of an assembled railway rail fastening system securing a rail foot of a railway rail to a rail support and is located at least partly between a bottom surface of the rail foot and the rail support. At Step 10 data derived from a 3D scan of a region comprising at least part of a top surface of the rail foot and at least one fixed point spaced from the rail is obtained. At Step S20 at least one measurement indicating a vertical distance between the top surface of the rail foot and the at least one fixed point is derived from the data. At Step S30 wear of the rail pad is assessed, based on the at least one measurement.

Measuring the height of the rail foot above, rather than that of the rail head, will typically provide a more reliable measurement, as it will not be influenced by rail head wear. Measurements of rail foot height on both sides of the rail may be averaged to obtain an overall assessment of pad wear. Alternatively, measurements of the height of the rail foot above the sleeper/baseplate on both sides of the rail may enable an assessment of rail cant to be made. Calculating the rail cant across the rail width will enable a determination to be made as to whether the rail pad has worn more on one side that the other, which is often the case, especially on curves.

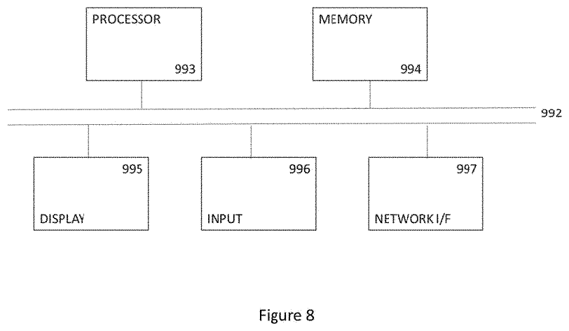

FIG. 8 is a block diagram of a computing device, such as a data storage server, which embodies the present invention, and which may be used to implement some or all of the operations of a method embodying the present invention, and perform some or all of the tasks of apparatus of an embodiment. For example, the computing device of FIG. 8 may be used to implement some or all the tasks described with reference to FIGS. 3A and 3B, or to implement some or all of the processes of the methods described with reference to FIGS. 2 and 7.

The computing device comprises a processor 993 and memory 994. Optionally, the computing device also includes a network interface 997 for communication with other such computing devices, for example with other computing devices of invention embodiments.

For example, an embodiment may be composed of a network of such computing devices. Optionally, the computing device also includes one or more input mechanisms such as keyboard and mouse 996, and a display unit such as one or more monitors 995. The components are connectable to one another via a bus 992.

The memory 994 may include a computer readable medium, which term may refer to a single medium or multiple media (e.g., a centralized or distributed database and/or associated caches and servers) configured to carry computer-executable instructions and/or store computer data such as 3D scans. Computer-executable instructions may include, for example, instructions and data accessible by and causing a general purpose computer, special purpose computer, or special purpose processing device (e.g., one or more processors) to perform one or more functions or operations. For example, the computer-executable instructions may include those instructions for implementing the method of FIG. 2 and/or the method of FIG. 7. Thus, the term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media. By way of example, and not limitation, such computer-readable media may include non-transitory computer-readable storage media, including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices).

The processor 993 is configured to control the computing device and execute processing operations, for example executing computer program code stored in the memory 994 to implement the methods described with reference to FIG. 2 and/or defined in the claims. The memory 994 stores data being read and written by the processor 993. As referred to herein, a processor may include one or more general-purpose processing devices such as a microprocessor, central processing unit, or the like. The processor may include a complex instruction set computing (CISC) microprocessor, reduced instruction set computing (RISC) microprocessor, very long instruction word (VLIVV) microprocessor, or a processor implementing other instruction sets or processors implementing a combination of instruction sets. The processor may also include one or more special-purpose processing devices such as an application specific integrated circuit (ASIC), a field programmable gate array (FPGA), a digital signal processor (DSP), network processor, or the like. In one or more embodiments, a processor is configured to execute instructions for performing the operations and operations discussed herein.

The display unit 995 may display a representation of data stored by the computing device, such as one or more 3D scans, and may also display a cursor and dialog boxes and screens enabling interaction between a user and the programs and data stored on the computing device. The input mechanisms 996 may enable a user to input data and instructions to the computing device.

The network interface (network I/F) 997 may be connected to a network, such as the Internet, and is connectable to other such computing devices via the network. The network I/F 997 may control data input/output from/to other apparatus via the network. Other peripheral devices such as microphone, speakers, printer, power supply unit, fan, case, scanner, trackerball etc may be included in the computing device.

Methods embodying the present invention may be carried out on a computing device such as that illustrated in FIG. 8. Such a computing device need not have every component illustrated in FIG. 8, and may be composed of a subset of those components. A method embodying the present invention may be carried out by a single computing device in communication with one or more data storage servers via a network. The computing device may be a data storage itself storing at least a portion of the data.

A method embodying the present invention may be carried out by a plurality of computing devices operating in cooperation with one another. One or more of the plurality of computing devices may be a data storage server storing at least a portion of the data.

The invention can be implemented in digital electronic circuitry, or in computer hardware, firmware, software, or in combinations of them. The invention can be implemented as a computer program or computer program product, i.e., a computer program tangibly embodied in a non-transitory information carrier, e.g., in a machine-readable storage device, or in a propagated signal, for execution by, or to control the operation of, one or more hardware modules.

A computer program can be in the form of a stand-alone program, a computer program portion or more than one computer program and can be written in any form of programming language, including compiled or interpreted languages, and it can be deployed in any form, including as a stand-alone program or as a module, component, subroutine, or other unit suitable for use in a data processing environment. A computer program can be deployed to be executed on one module or on multiple modules at one site or distributed across multiple sites and interconnected by a communication network.

Method steps of the invention can be performed by one or more programmable processors executing a computer program to perform functions of the invention by operating on input data and generating output. Apparatus of the invention can be implemented as programmed hardware or as special purpose logic circuitry, including e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions coupled to one or more memory devices for storing instructions and data.

The above-described embodiments of the present invention may advantageously be used independently of any other of the embodiments or in any feasible combination with one or more others of the embodiments.

1. A computer-implemented method of assessing wear of a side post of an electrical insulator, wherein the electrical insulator is part of an assembled railway rail fastening system securing a rail foot of a railway rail, the method comprising:
obtaining data derived from a three-dimensional, 3D, scan of a region comprising at least part of the rail and at least a reference portion of the assembled railway rail fastening system;
deriving from the data at least one measurement indicating a distance between a point on the rail and the reference portion of the assembled railway rail fastening system; and
assessing wear of the side post of the electrical insulator based on the at least one measurement.

2. A method as claimed in claim 1, wherein the reference portion is a portion of a rail clip anchoring device of the assembled railway rail fastening system.

3. A method as claimed in claim 2, wherein the portion of the rail clip anchoring device is a front edge of the rail clip anchoring device adjacent to the edge of the rail foot, or a rear edge of the rail clip anchoring device opposite to the front edge.

4. A method as claimed in claim 1, wherein the rail is supported by a railway baseplate providing or connected to a rail clip anchoring device of the assembled railway fastening system, and the reference portion is a portion of the railway baseplate.

5. A method as claimed in claim 1, wherein the point on the rail is on one of the edges of the rail foot.

6. A method as claimed in claim 1, wherein assessing wear of the side post of the electrical insulator comprises:
comparing the derived value of the measurement with a stored value for the measurement; and
outputting the result of the comparison.

7. A method as claimed in claim 6, wherein the stored value is obtained from data derived from an earlier 3D scan of the region.

8. A method as claimed in claim 6, wherein the stored value is one of: a value of the measurement for the electrical insulator obtained before the railway rail fastening system was assembled; a typical value of the measurement for an unused electrical insulator of the same type as the electrical insulator in the assembled railway rail fastening system.

9. A method as claimed in claim 1, wherein obtaining the data comprises:
extracting measurement data from an image produced from a combination of an image of the region obtained from the 3D scan with one of (i) an image of a 3D model of the assembled railway rail fastening system and (ii) an image of the assembled railway rail fastening system created before the 3D scan.

10. A method as claimed in claim 1, further comprising, before assessing wear, using the 3D scan to determine at least one of: an identity of the assembled railway rail fastening system; a type of the assembled railway rail fastening system; a type of the electrical insulator; a type of a component of the assembled railway rail fastening system other than the electrical insulator.

11. A method as claimed in claim 10, wherein determining the identity or type is carried out by:
matching the 3D scan with at least part of (i) an assembled railway rail fastening system from a database of assembled railway rail fastening systems or (ii) a 3D model of an assembled railway rail fastening system from a database of 3D models of assembled railway rail fastening systems; and
determining that the assembled railway rail fastening system matched with the 3D scan is an assembled railway rail fastening system having the same identity, or is of the same type, as the assembled railway rail fastening system in the 3D scan.

12. A method as claimed in claim 11, wherein assessing wear comprises using a stored value for the measurement which is associated with the assembled railway rail fastening system with which the assembled railway rail system in the 3D scan has been matched.

13. A method as claimed in claim 10, wherein determining the identity or type is carried out using a neural network trained as a classifier.

14. A method as claimed in claim 1, wherein each 3D scan is obtained using one of: a LiDAR scanner; a structured light scanner; a stereo depth scanner.

15. A computer-implemented method of assessing wear of a rail pad, wherein the rail pad is part of an assembled railway rail fastening system securing a rail foot of a railway rail to a rail support and is located at least partly between a bottom surface of the rail foot and the rail support, the method comprising:
obtaining data derived from a three-dimensional, 3D, scan of a region comprising at least part of a top surface of the rail foot and at least one fixed point spaced from the rail;
deriving from the data at least one measurement indicating a vertical distance between the top surface of the rail foot and the at least one fixed point; and
assessing wear of the rail pad based on the at least one measurement.

16. A method as claimed in claim 15, wherein:
(i) the rail support is a track foundation, and the fixed point is located on a top surface of the track foundation, or
(ii) the rail support is a baseplate secured to a track foundation, and the fixed point is located on a top surface of the baseplate or the track foundation.

17. A method as claimed in claim 15, wherein the at least one measurement indicates the thickness of the rail pad beneath the rail foot on one side of the rail.

18. A method as claimed in claim 15, wherein:
the region in the 3D scan comprises at least a part of the top surface of the rail foot on each side of the rail; and
at least two measurements are derived from the data, one of the measurements indicating a vertical distance between the top surface of the rail foot on one side of the rail and the at least one fixed point, and another of the measurements indicating a vertical distance between the top surface of the rail foot on the other side of the rail and either the at least one fixed point or another fixed point visible in the 3D scan.

19. A method as claimed in claim 18, wherein the at least two measurements indicate the respective thicknesses of the rail pad beneath the rail foot on each side of the rail.

20. A method as claimed in claim 18, wherein the at least two measurements are either (i) averaged to obtain an assessment of the overall wear of the rail pad beneath the rail foot, or (ii) used to determine an angle of cant of the rail from which an assessment of wear of the rail pad on each side of the rail may be obtained.

21. A method as claimed in claim 15, wherein obtaining the data comprises:
extracting measurement data from an image produced from a combination of an image of the region obtained from the 3D scan with one of (i) an image of a 3D model of the assembled railway rail fastening system and (ii) an image of the assembled railway rail fastening system created before the 3D scan.

22. A method as claimed in claim 15, further comprising, before assessing wear, using the 3D scan to determine at least one of: an identity of the assembled railway rail fastening system; a type of the assembled railway rail fastening system; a type of the electrical insulator; a type of a component of the assembled railway rail fastening system other than the electrical insulator.

23. A method as claimed in claim 22, wherein determining the identity or type is carried out by:
matching the 3D scan with at least part of (i) an assembled railway rail fastening system from a database of assembled railway rail fastening systems or (ii) a 3D model of an assembled railway rail fastening system from a database of 3D models of assembled railway rail fastening systems; and
determining that the assembled railway rail fastening system matched with the 3D scan is an assembled railway rail fastening system having the same identity, or is of the same type, as the assembled railway rail fastening system in the 3D scan.

24. A method as claimed in claim 23, wherein assessing wear comprises using a stored value for the measurement which is associated with the assembled railway rail fastening system with which the assembled railway rail system in the 3D scan has been matched.

25. A method as claimed in claim 22, wherein determining the identity or type is carried out using a neural network trained as a classifier.

26. A method as claimed in claim 15, wherein each 3D scan is obtained using one of: a LiDAR scanner; a structured light scanner; a stereo depth scanner.
